(19) United States
(12) Patent Application Publication
(10) Pub. No.: US 2006/0182556 A1
(43) Pub. Date: Aug. 17, 2006

(54) Substrate transportation device (wire)

(75) Inventors: Shiang-Chiang Liu, Taipei City (TW); Tsung-Lin Lu, Dongshan Township (TW); Ying-Chi Chen, Taoyuan City (TW)

Correspondence Address: ARENT FOX PLLC, 1050 CONNECTICUT AVENUE, N.W., SUITE 400, WASHINGTON, DC, 20036, US

(73) Assignee: AU OPTRONICS CORPORATION

(21) Appl. No.: 11/030,954

(22) Filed: Jan. 10, 2005

(51) Int. Cl. B65G 1/00

(52) U.S. Cl. 414/331.01

(57) ABSTRACT

A substrate transportation device includes a housing formed of an upper surface, a lower surface, and opposing sidewalls. The housing has a rear opening through which the substrate enters the housing and a front opening through which the substrate exit the housing. A plurality supporting members are disposed within the housing and operatively connected to the opposing sidewalls which can be formed as a plurality of columns. A motor and motor shaft transmit a rotational force to an axle system, which transmits rotational force to the supporting members to transfer the substrate into or out of the housing randomly.

### BACKGROUND OF THE INVENTION

1. Field of the Invention

This invention relates to a substrate transportation device. More specifically, the present invention relates to a substrate transportation device for transporting a material, for example, a glass tray from one location to another, and providing sufficient support for the entire body of the tray, and thereby improving the transportation of the substrate in an efficient and timely manner.

2. Description of the Related Art

Automation and robotics are used in substrate transportation to improve the efficiency of transportation, and serve to reduce human contamination of the glass tray, used in the contamination-sensitive thin film transistor liquid crystal displays (TFT-LCD). Such a glass tray is manufactured in clean-room environments.

When a large glass tray is placed in a housing by a robotic apparatus, the tray must be supported underneath. This is often accomplished by a grid structure. As shown in FIG. 1, the grid structure is formed by rows of horizontally disposed pairs of supporting grids 80 that extend toward the center of the housing 10 from the inner walls of the housing. The grids 80 are vertically spaced to allow a glass tray 22 to be supported by each pair of grids. One of the purposes of having the grid structure only partially extending across the housing is to minimize contact with the surface of the glass tray and thereby reduce contamination. However, the arrangement of the existing grids in current housings causes the glass trays to droop or sag in the middle, because there is no support for the middle of the glass tray. Sagging of the glass trays causes the trays to become undesirably bent. Further, the sagging of the glass trays causes the trays to have a vertically concave cross section, resulting in glass trays that occupy a vertical space that is greater than the thickness of the glass tray. See FIG. 1. As such, fewer glass trays can be transported through the housing.

In order to increase the number of glass trays that can be supported as well as transported through the housing, another type of supporting system was developed. FIG. 2 illustrates supporting lines 82 for supporting the glass trays 22. The supporting lines 82 are shown as having end portions that are fastened to the inner walls of the housing 10 and span the width of the housing. Although each supporting line 82 supports the entire body of the glass tray, the weight of the tray causes the supporting line, and therefore the tray, to sag in the middle. Further, the supporting lines are arranged in such close proximity to each other that a robotic device cannot access, and thereby transport, the trays to and from the housing. In this arrangement, the glass trays must be transported by an axle system underneath each glass tray, which can only dispense the trays one by one.

Therefore, there is a need for an improved device and method for transporting a substrate that minimizes contact with the housing, but supports both the ends and the middle of the substrate.

### SUMMARY OF THE INVENTION

The present invention relates to a transportation device for storing, supporting and transporting a substrate such as a glass tray during manufacture, so that the substrate does not bend or come in contact with the housing or cassette of the transportation device. The transportation device is one stage in a cassette station system for manufacturing and transporting glass trays. Glass trays are used as an example, however, the present invention is not limited to transporting glass trays, and any kind of substrate can benefit from the transportation device of the present invention. Glass trays include, for example, thin film transistor liquid crystal display panels (TFT-LCD), which are used in applications ranging from mobile telephones to computer monitor screens to flat panel televisions. As such, sagging and bending due to weak support for the middle of the glass tray can result in physical damage to or permanent deformation of the glass tray, making the tray unsuitable for use. Among other things, the substrate transportation device of the present invention provides a plurality of supporting members such as, for example, wires of adjustable rigidity to support the substrate in the housing, thereby providing sufficient strength to the supporting members that eliminate sagging or drooping of the substrate in the housing.

The housing of the substrate transportation device is sized to accommodate a plurality of substrates of varying dimensions. The housing includes a frame having an upper surface, a lower surface, and a set of opposing sidewalls. The opposing sidewalls can be formed as a plurality of parallel arrayed columns extending from the upper surface of the housing to the lower surface. Each column can support a plurality of vertically arrayed, uniformly spaced supporting members.

The supporting members can be made from a metal tube, engineering plastic, or fiber-reinforced plastic tube or any suitable material and have an arcuate-shaped surface. Metallic supporting members include wires. The supporting members can be fastened to the sidewalls or columns at one or both ends through at least one axle system.

The supporting members are fastened by their opposite ends to the sidewalls of the housing and through the axle system which connects each supporting member to a motor. The motor shaft generates a rotational driving force to drive the supporting member to rotate clockwise or counterclockwise. The rotation of the motor shaft allows the axle system to rotate the supporting members in a predetermined direction. Rotation of the axle system pulls the substrate into or out of the cassette. For example, the axle system can pull the substrate forward or backward to transfer the substrate out of or into the cassette.

The motor is mounted within a simultaneous operation device. The simultaneous operation device is operatively connected to an outer surface of at least one of the sidewalls, outside of the housing. The simultaneous operation device is movable vertically along and horizontally toward and away from the sidewalls of the housing. The motor shaft extends from the simultaneous operation device and is operatively connected to a plurality of axle systems through apertures in the sidewalls and serves to rotate the axle systems and thereby the supporting members.

The present invention also allows for a plurality of substrates to be more closely arranged in the housing because rigid supporting members spanning the width of the housing support the substrate underneath and across the middle. As a result, the substrate can remain substantially planar in that sagging or bending of the substrate is eliminated and the upper substrates do not sag toward the lower substrates.

The axle system includes a forward push axle, a side board, and a set of bearings for reducing friction, between the side board and the forward push axle. The substrate can be disposed substantially horizontally in the housing on the supporting members, until the robotic or automated device transports the substrate. When the substrate is supported on the rigid supporting members, it is easier for the substrate to be transported, and only a minimal force is required to discharge the substrate from the housing.

In one embodiment of the present invention, the supporting members can be disposed in the same horizontal plane with each other from a front to rear direction of the housing so that the substrate can be laid flat thereon. In this arrangement, rotation of the supporting members moves the substrate in a horizontal plane to slide or transport the substrate through the front of the housing.

As a result of the present invention, the housing of the substrate transportation device can accommodate more substrates, maintain the efficient use of the robotic arm for moving the substrates into and out from the housing.

Additional advantages and novel features of the invention are set forth in the attachments to this summary, and in part will become more apparent to those skilled in the art upon examination of the following or upon learning by practice of the invention.

### BRIEF DESCRIPTION OF THE DRAWINGS

The features of the invention will be more readily understood with reference to the following description and the attached drawings, wherein:

FIG. 1 illustrates a front view of a conventional glass tray supporting device with a grid structure;

FIG. 2 illustrates a front view of a conventional glass tray supporting device with supporting members;

FIG. 3 illustrates a perspective view of an example substrate transportation device in accordance with a first embodiment of the present invention;

FIG. 4 illustrates a front view of an example substrate transportation device in accordance with a first embodiment of the present invention;

FIG. 5 illustrates a top view of an example substrate transportation device in accordance with the first embodiment of the present invention; and

FIG. 6 illustrates cassette station system comprising the substrate transportation device.

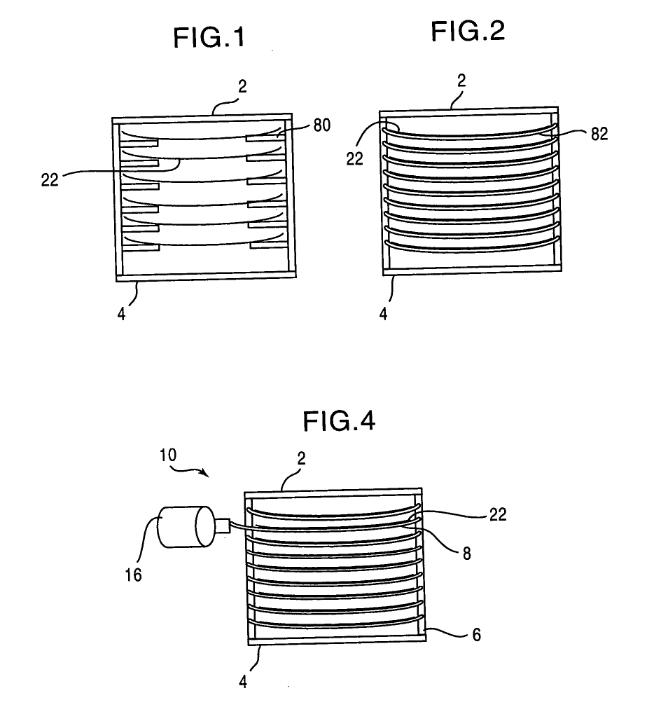

### DETAILED DESCRIPTION OF THE INVENTION

The present invention is directed to a substrate transportation device for transporting and supporting such as, for example a glass tray, during manufacture. A glass tray can include a thin film transistor liquid crystal display panel.

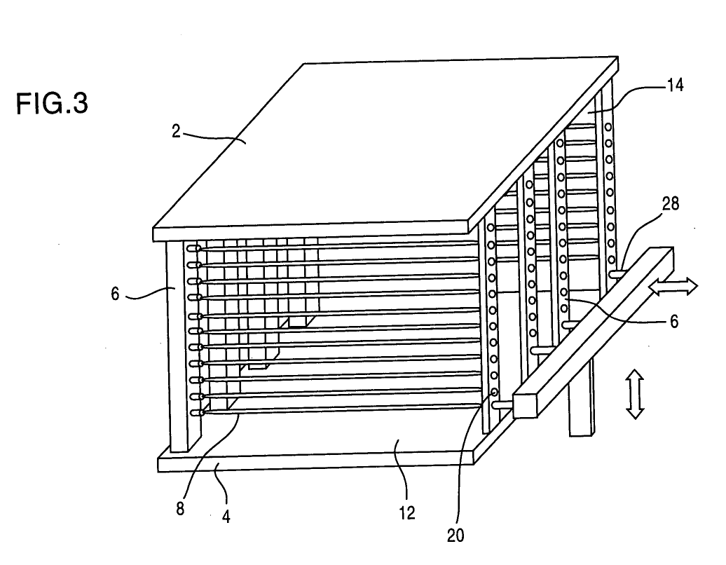

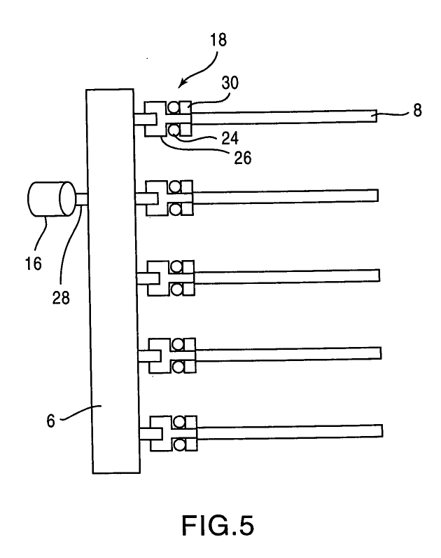

As shown in FIG. 4, the substrate transportation device includes a housing 10 for transporting a substrate 22. The cassette or housing 10 includes an upper surface 2, a lower surface 4, and opposing sidewalls 6 which can be formed as a plurality of columns. As shown in FIG. 3, there is a rear opening 14 through which the substrate 22 enters the housing 10 and a front opening 12 through which the substrate 22 exits the housing 10. The housing 10 is illustrated in FIGS. 3 and 4 as having a rectangular shape, however, the housing can be any other appropriate shape. The housing 10 and sidewalls 6 can be made of any material including, but not limited to a metal tube, engineering plastic, or a fiber reinforced plastic tube.

Supporting members 8 shown in FIG. 3, extend horizontally between the opposing sidewalls 6 of the housing 10 across the entire width of the housing 10 where they are fastened with proper tension at both ends to the inner surfaces of the sidewalls 6. The supporting members 8, in one embodiment of the present invention, are wires, but the supporting members can be made from any material having adjustable levels of rigidity. For example, the supporting members 8 can be made any material including, but not limited to, steel or copper wire.

A motor or driving unit 16 can be mounted to the housing 10 in order to rotate the supporting members 8. The supporting members 8 can provide a rigid support for the substrate with suitable force. The substrate can be disposed substantially horizontally in the housing on the supporting members. When the substrate is supported on rigid supporting members 8, it is easier for the substrate to be transported from the housing. The motor 16 can be mounted in a simultaneous operation device operatively connected to an outer surface of the opposing sidewalls 6 of the housing.

A plurality of axle systems 18 is illustrated in FIG. 5. The axle system is used to rotate the supporting members 8 for transporting the substrate 22. The axle system 18 links the motor 16 to the supporting members 8 so that in operation, the motor generates a rotational force through a motor shaft 28 to the axle system 18. The axle system converts the rotational motion of the motor shaft 28 to rotate the supporting members 8, hence, the substrate 22 can be transported into the housing 8 via the rear opening 14 and out of housing 8 via the front opening 12. The axle system 18 includes a forward push 26 axle, a side board 30, and a set of bearings 24 for reducing friction, between the side board 30 and the forward push axle 26.

In another embodiment of the present invention, the axle system 18 can be connected to both ends of each supporting member 8. Likewise, a motor 16 can be mounted on both sidewalls 6 of the housing 10 to supply a rotational force to the axle system 18 at each end of the supporting members 8.

The substrate transportation device of the present invention also includes a control unit (not shown) to control the rotation of the supporting members 8. The control unit sends a signal to the motor 16 so that the motor shaft 28 can rotate to thereby transfer the substrate. The supporting members 8 can be arranged such that at least two supporting members support a single substrate 22.

As shown in FIG. 3, the sidewalls 6 can be formed as a plurality of columns. Each sidewall 6 has an inner surface that faces the inner surface of an opposing sidewall and an outer surface that faces away from the opposing sidewall. The sidewalls have a plurality of apertures 20 for receiving the motor shaft 28. Rotation of the motor shaft drives the axle system which, in turn, rotates the supporting members in a predetermined direction. In a first embodiment of the present invention, the supporting members 8 are uniformly spaced in a vertical direction along the length of the sidewall 6.

In transporting the substrate 22 on the reinforced or rigid supporting members 8, a rotational force of the supporting members can move the substrate 22, disposed thereon, out of the housing. Also, having the substrate 22 positioned at a slight incline toward the front opening of the housing allows the substrate to more easily slide out of the housing. The present invention also includes a method of transporting a substrate into and out of the housing. The method includes generating a driving force from the motor 16 to rotate the supporting members 8. The motor shaft 28 transmits rotational force from the motor 16 to the axle system 18, which rotates the wire supporting members 8. Hence, the substrate 22 is inserted, by a first portion, into the housing and onto the supporting members, and then transported from the housing. The substrate 22 can be transported from the housing by the rotational motion of the supporting members, which is controlled by the control unit.

In the present invention, a plurality of substrates can be simultaneously inserted into and simultaneously discharged from the housing.

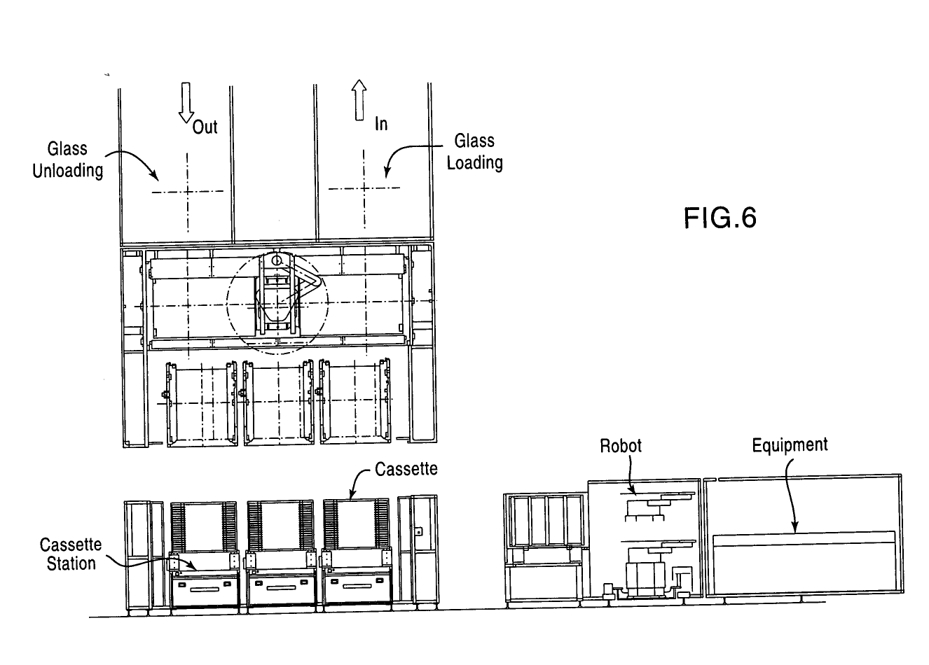

FIG. 6 illustrates a cassette station system comprising the substrate transportation device of the present invention. In the cassette station system, glass such as a TFT-LCD is manufactured, in a clean room environment. Then the substrate is moved by an automated unit, such as a robotic arm, from the manufacturing stage to the housing or cassette 10 where it is loaded for the next stage. In the housing, the substrate 22 is supported on supporting members having a rigidity produced by a preload on the supporting members. The motor 16 can be mounted on one of the opposing sidewalls of the housing. The axle system 18 connects the supporting members to the motor 16 so that the axle system receiving the driving force through the motor shaft unit can exerts a rotational force on the supporting members. The rotational force on the supporting members can transport the substrates into and out of the housing.

Example embodiments of the present invention have now been described in accordance with the above advantages. It will be appreciated that these examples are merely illustrative of the invention. Many variations and modifications will be apparent to those skilled in the art.

We claim:

1. A substrate transportation device comprising:
a housing having a front opening and a rear opening;
an array of supporting members disposed within the housing;
a plurality of axle systems attached to at least one opposing end of the supporting members; and
at least one driving unit to generate a rotational force transmitted to the axle systems to rotate the axle systems.

2. The substrate transportation device according to claim 1, wherein the axle systems further comprise a side board and a set of bearings to reduce friction of a preset tension of the supporting members.

3. The substrate transportation device according to claim 1, further comprising a simultaneous operation device to simultaneously engage the plurality of axle systems.

4. The substrate transportation device according to claim 1, wherein each of the supporting members extends horizontally between opposing sidewalls of the housing and is fastened thereto.

5. The substrate transportation device according to claim 4, wherein each of the opposing sidewalls comprises a plurality of columns.

6. The substrate transportation device according to claim 5, wherein each of the supporting members extends horizontally between opposing columns of the housing.

7. The substrate transportation device according to claim 1, wherein the supporting members are formed from steel wire.

8. The substrate transportation device according to claim 1, wherein the supporting members comprise wires.

9. The substrate transportation device according to claim 1, wherein at least one of the plurality of axle systems is disposed at each end of the supporting members.

10. A method of transporting a substrate into and out of a housing, the method comprising:
providing a housing having a front opening, a rear opening, and a plurality of supporting members vertically arrayed across the width of the housing;
inserting a substrate, by a first portion, into the housing and onto the supporting members; and
transporting the substrate from the housing.

11. The method according to claim 10, wherein the step of generating a driving force comprises generating a rotational force.

12. The method according to claim 10, wherein the step of transporting the substrate from the housing comprises rotating the plurality of supporting members in a predetermined direction.

13. The method according to claim 10, further comprising the step of controlling tightening of the supporting members.

14. The method according to claim 12, wherein the step of transporting the substrate out from the housing comprises controlling a robotic arm to transport the substrate out from the housing.

15. The method according to claim 10, wherein the step of inserting comprises simultaneously inserting a plurality of substrates into the housing.

16. The method according to claim 10, wherein the step of transporting comprises simultaneously discharging a plurality of substrates from the housing.
